(19) United States
(12) Patent Application Publication
(10) Pub. No.: US 2022/0086321 A1
(43) Pub. Date: Mar. 17, 2022

(54) REDUCED DIFFRACTION MICRO LENS IMAGING

(71) Applicant: Micron Technology, Inc., Boise, ID (US)

(72) Inventor: Zahra Hosseinimakarem, Boise, ID (US)

(21) Appl. No.: 17/020,949

(22) Filed: Sep. 15, 2020

(51) Int. Cl. H04N 5/238; H04N 5/225; H04N 7/18; G02B 3/00

(52) U.S. Cl. CPC H04N 5/238; H04N 5/2258; G02B 3/0037; H04N 7/183; H04N 5/2254

(57) ABSTRACT

Methods and devices related to reduced diffraction micro lens imaging are described. In an example, a method can include receiving light, via an array of micro lenses including embedded optics configured to reduce diffraction relative to a threshold value associated with another array of micro lenses without embedded optics, at an array of image sensors coupled to the array of micro lenses and positioned to receive the light in response to the light passing through the array of micro lenses, and generating an image from the light at the array of image sensors based at least in part on reduced diffraction of the light.

### TECHNICAL FIELD

The present disclosure relates generally to reduced diffraction micro lens imaging.

### BACKGROUND

A micro lens can be a lens with a diameter less than, for example, a millimeter. A plurality of micro lenses can be formed on a substrate to create a micro lens array.

An image sensor can convert an optical image into an electrical signal. Image sensors, also referred to as imagers, can be included in digital cameras, camera modules, camera phones, medical imaging equipment, night vision, radar, and sonar, for example. These devices can include memory.

Memory devices are typically provided as internal, semiconductor, integrated circuits in computers or other electronic devices. There are many different types of memory including volatile and non-volatile memory. Volatile memory can require power to maintain its data and includes random-access memory (RAM), static random access memory (SRAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), 3D XPoint™, resistive random access memory (RRAM), and magnetoresistive random access memory (MRAM), among others.

Memory is also utilized as volatile and non-volatile data storage for a wide range of electronic applications, including, but not limited to personal computers, portable memory sticks, digital cameras, cellular telephones, portable music players such as MP3 players, movie players, and other electronic devices. Memory cells can be arranged into arrays, with the arrays being used in memory devices.

Computers or other electronic devices can include a number of memory devices. In some examples, different types of memory can be included on the same electronic device for optimal performance of the electronic device. However, different types of memory devices may require separate data paths and/or controls for each type of memory device.

### BRIEF DESCRIPTION OF THE DRAWINGS

FIG. 1 illustrates an example of an apparatus for receiving light, via an array of micro lenses including embedded optics, at an array of image sensors in accordance with a number of embodiments of the present disclosure.

FIG. 2 illustrates an example of an apparatus for receiving light, via a micro lens including embedded optics, at an image sensor in accordance with a number of embodiments of the present disclosure.

FIG. 3 illustrates an example of an apparatus for receiving light, via a micro lens including embedded optics, at an image sensor in accordance with a number of embodiments of the present disclosure.

FIG. 4 is a flow diagram of a method for receiving light, via an array of micro lenses including embedded optics, at an array of image sensors in accordance with a number of embodiments of the present disclosure.

### DETAILED DESCRIPTION

The present disclosure includes methods and apparatuses related to receiving light, via an array of micro lenses including embedded optics configured to reduce diffraction relative to a threshold value associated with another array of micro lenses without embedded optics, at an array of image sensors coupled to the array of micro lenses and positioned to receive the light in response to the light passing through the array of micro lenses, and generating an image from the light at the array of image sensors based at least in part on reduced diffraction of the light.

Diffraction is the spreading out of light waves. Light can diffract and lose its intensity with distance. As used herein, embedded optics can be attached to and/or a portion of a micro lens. The embedded optics can be shaped to reduce or prevent light, received by the micro lens, from diffracting. For example, the micro lens including the embedded optics can receive light as a Gaussian beam and convert the light to a Bessel-Gauss beam by passing the light through the embedded optics. As a result, the embedded optics can increase a depth of focus of an image.

An array of micro lenses each including embedded optics can each receive and pass through a different portion of light. The embedded optics can include an axicon, a cubic phase plate, and/or a polarization conversion plate, for example. An axicon is a cone shaped optical element with a circular aperture. A cubic phase plate can be a surface that has a phase distribution including a third order dependence with respect to spatial coordinates. The third order dependence can be achieved via thickness variation or sub-wavelength nanostructures of the cubic phase plate. In some examples, an array of radial, azimuthal, and/or linear polarization conversion plates can be the embedded optics. The array of radial, azimuthal, and/or linear polarization conversion plates can be used to increase a depth of focus of an image and/or enhance a light signal (e.g., increase a signal to noise ratio of the light).

In a number of embodiments, an axicon, a cubic phase plate, and/or a polarization conversion plate can be used in conjunction with an image sensor. Placing an axicon, a cubic phase plate, and/or a polarization conversion plate in front of an image sensor will reduce diffraction of the light received by the image sensor. This allows the light to maintain its intensity over a greater distance. In some examples, an apparatus including an axicon, a cubic phase plate, and/or a polarization conversion plate and an image sensor can capture an image at a greater distance away from the apparatus than an apparatus including the image sensor without the axicon, the cubic phase plate, and/or the polarization conversion plate.

The image sensor can be, for example, a complementary metal oxide semiconductor (CMOS) sensor and/or a charge-coupled device (CCD). A CMOS sensor can include a number of metal-oxide-semiconductor field-effect transistor (MOSFET) amplifiers and a CCD can include a number of metal-oxide-semiconductor (MOS) capacitors. The image sensor can convert a number of photons from the light to a number of electrons to generate an image. A portion of light can be received at each image sensor of an array of image sensors and each image sensor of the array of image sensors can generate an image from the portion of light it received.

A processing resource can receive an image from each image sensor of the array of image sensors. A picture can be created by combining the images received. In some examples, the picture and/or the images can be stored in a memory coupled to the processing resource.

As used herein, “a number of” something can refer to one or more of such things. For example, a number of image sensors can refer to one or more image sensors. A “plurality” of something intends two or more. Additionally, designators such as “X” and “Y”, as used herein, particularly with respect to reference numerals in the drawings, indicates that a number of the particular feature so designated can be included with a number of embodiments of the present disclosure.

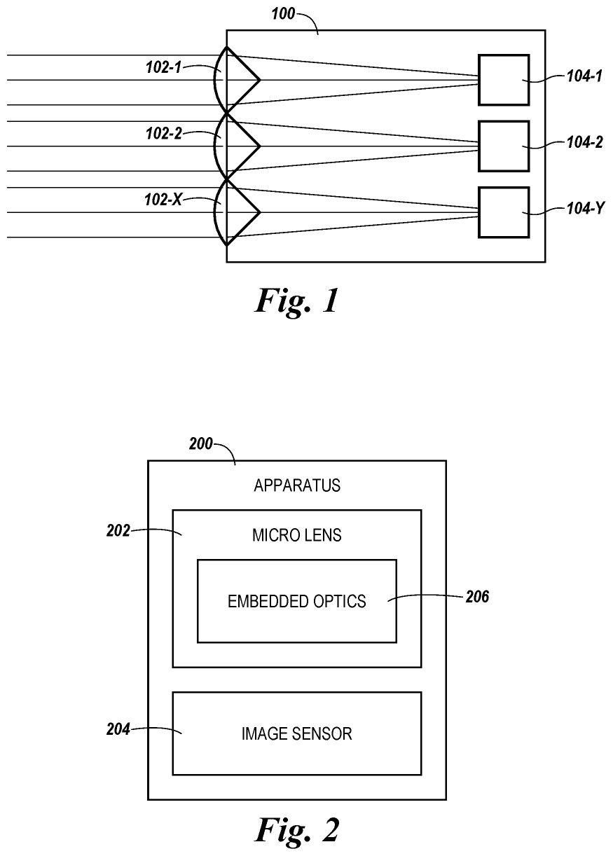

The figures herein follow a numbering convention in which the first digit or digits correspond to the drawing figure number and the remaining digits identify an element or component in the drawing. Similar elements or components between different figures may be identified by the use of similar digits. For example, reference numeral 102 may reference element “2” in FIG. 1, and a similar element may be referenced as 202 in FIG. 2. In some instances, a plurality of similar, but functionally and/or structurally distinguishable, elements or components in the same figure or in different figures may be referenced sequentially with the same element number (e.g., 102-1, 102-2, and 102-X in FIG. 1). As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

FIG. 1 illustrates an example of an apparatus 100 for receiving light, via an array of micro lenses 102-1, 102-2, . . . , 102-X including embedded optics, at an array of image sensors 104-1, 104-2, . . . , 104-Y in accordance with a number of embodiments of the present disclosure. The apparatus 100 can be, but is not limited to, a baby monitor, a security camera (e.g., surveillance camera), a door camera, a trail camera, a tablet camera, a digital camera, a personal laptop camera, a desktop computer camera, a smart phone camera, a wrist worn device camera, an imaging device, a detection device, and/or redundant combinations thereof.

Each micro lens of the array of micro lenses 102-1, 102-2, . . . , 102-X can be less than a millimeter in diameter. A plurality of micro lenses 102-1, 102-2, . . . , 102-X can be formed on a substrate to create the array of micro lenses 102-1, 102-2, . . . , 102-X, as illustrated in FIG. 1. Each micro lens of the array of micro lenses 102-1, 102-2, . . . , 102-X can include embedded optics, which can reduce or prevent diffraction of light received by each image sensor of the array of image sensors 104-1, 104-2, . . . , 104-Y. The embedded optics can reduce diffraction relative to a threshold value associated with another array of micro lenses without embedded optics. For example, the embedded optics can reduce diffraction by 90 centimeters.

As illustrated in FIG. 1, the light is diffracted when received by the array of micro lenses 102-1, 102-2, . . . , 102-X. For example, the light can be received as a Gaussian beam. As the light passes through the embedded optics included in each micro lens of the array of micro lenses 102-1, 102-2, . . . , 102-X, the diffraction of the light can be reduced and/or eliminated, as illustrated in FIG. 1. For example, the embedded optics can convert the light from a Gaussian beam to a Bessel-Gaus beam.

Each image sensor of the array of image sensors 104-1, 104-2, . . . , 104-Y can receive light that passed through the array of micro lenses 102-1, 102-2, . . . , 102-X and convert an optical image of the light into an electrical signal. For example, the array of image sensors 104-1, 104-2, . . . , 104-Y can convert a number of photons from the light to a number of electrons to generate an image. In a number of embodiments, a portion of light can be received at each image sensor of the array of image sensors 104-1, 104-2, . . . , 104-Y. Each image sensor of the array of image sensors 104-1, 104-2, . . . , 104-Y can convert a number of photons from their portion of light to a number of electrons to generate an image.

The image sensors 104-1, 104-2, . . . , 104-Y can be, for example, complementary metal oxide semiconductor (CMOS) sensors and/or charge-coupled devices (CCD). A CMOS sensor can include a number of metal-oxide-semiconductor field-effect transistor (MOSFET) amplifiers and a CCD can include a number of metal-oxide-semiconductor (MOS) capacitors. The array of image sensors 104-1, 104-2, . . . , 104-Y can be and/or can be included in digital cameras, camera modules, camera phones, medical imaging equipment, night vision, radar, and sonar, for example.

As previously described, the array of image sensors 104-1, 104-2, . . . , 104-Y receiving the light after the light has passed through the array of micro lenses 102-1, 102-2, . . . , 102-X reduces and/or prevents diffraction of the light. Light with little or no diffraction allows the array of image sensors 104-1, 104-2, . . . , 104-Y to generate an image from the light with a greater depth of focus, which can make the objects present in the image detectable at a larger distance. For example, the array of image sensors 104-1, 104-2, . . . , 104-Y can capture an image at a greater distance away by utilizing the array of micro lenses 102-1, 102-2, . . . , 102-X including embedded optics.

FIG. 2 illustrates an example of an apparatus 200 for receiving light, via a micro lens 202 including embedded optics 206, at an image sensor 204 in accordance with a number of embodiments of the present disclosure. Apparatus 200 can correspond to apparatus 100 in FIG. 1. The apparatus 200 can be, but is not limited to, a baby monitor, a security camera, a door camera, a trail camera, a tablet camera, a digital camera, a personal laptop camera, a desktop computer camera, a smart phone camera, a wrist worn device camera, an imaging device, a detection device, and/or redundant combinations thereof.

The apparatus 200 can include a micro lens 202 and an image sensor 204, which can correspond to micro lens 102 and image sensor 104, respectively in FIG. 1. The micro lens 202 can include embedded optics 206 to reduce and/or prevent diffraction of the light prior to the light being received by the image sensor 204.

Diffraction is the spreading out of light waves. Light can diffract and lose its intensity with distance. The embedded optics 206 can be coupled to or be a portion of micro lens 202. The embedded optics 206 can be shaped to prevent light received by the image sensor 204 from being diffracted and/or decrease the amount of diffraction of the light.

The embedded optics 206 can include an axicon, a cubic phase plate, and/or a polarization conversion plate, for example. An axicon is a cone shaped optical element with a circular aperture. A cubic phase plate can be a surface that has a phase distribution including a third order dependence with respect to spatial coordinates. The third order dependence can be achieved via thickness variation or sub-wavelength nanostructures of the cubic phase plate. In some examples, an array of radial, azimuthal, and/or linear polarization conversion plates can be the embedded optics. The array of radial, azimuthal, and/or linear polarization conversion plates can be used to increase a depth of focus of an image and/or increase a signal to noise ratio of light.

In a number of embodiments, an axicon, a cubic phase plate, and/or a polarization conversion plate can be used in conjunction with the image sensor 204. Placing an axicon, a cubic phase plate, and/or a polarization conversion plate in front of an image sensor 204 will reduce diffraction of the light received by the image sensor 204. This allows the light to maintain its intensity over a greater distance. In some examples, apparatus 200 including an axicon, a cubic phase plate, and/or a polarization conversion plate and an image sensor 204 can capture an image at a greater distance away from the apparatus 200 than an apparatus 200 including the image sensor 204 without the axicon, the cubic phase plate, and/or the polarization conversion plate.

The image sensor 204 can receive light that passed through the micro lens 202 and convert an optical image of the light into an electrical signal. For example, the image sensor 204 can convert a number of photons from the light to a number of electrons to generate an image.

The image sensor 204 can be, for example, a complementary metal oxide semiconductor (CMOS) sensor and/or a charge-coupled device (CCD). A CMOS sensor can include a number of metal-oxide-semiconductor field-effect transistor (MOSFET) amplifiers and a CCD can include a number of metal-oxide-semiconductor (MOS) capacitors. The image sensor 204 can be and/or can be included in digital cameras, camera modules, camera phones, medical imaging equipment, night vision, radar, and sonar, for example.

As previously described, the image sensor 204 receiving the light after the light has passed through the micro lens 202 reduces and/or prevents diffraction of the light. Light with little or no diffraction allows the image sensor 204 to generate an image from the light with a greater depth of focus, which can make the objects present in the image detectable at a larger distance. For example, the image sensor 204 can capture an image at a greater distance away by utilizing the micro lens 202 including the embedded optics 206.

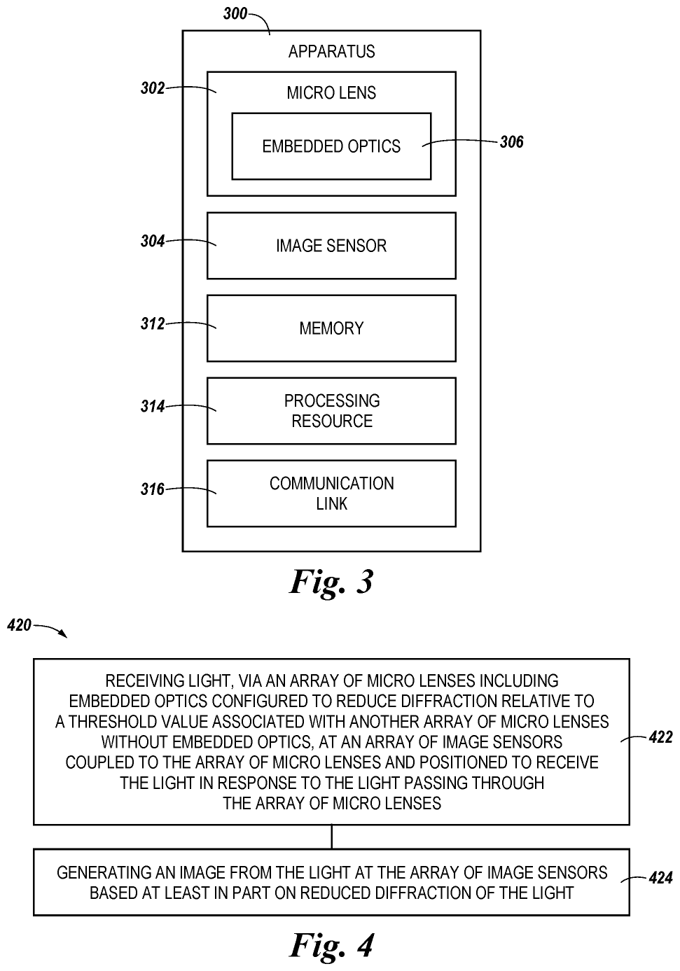

FIG. 3 illustrates an example of an apparatus 300 for receiving light, via a micro lens 302 including embedded optics 306, at an image sensor 304 in accordance with a number of embodiments of the present disclosure. Apparatus 300 can correspond to apparatus 100 in FIG. 1 and/or apparatus 200 in FIG. 2. The apparatus 300 can be, but is not limited to, a baby monitor, a security camera, a door camera, a trail camera, a tablet camera, a digital camera, a personal laptop camera, a desktop computer camera, a smart phone camera, a wrist worn device camera, an imaging device, a detection device, and/or redundant combinations thereof.

The apparatus 300 can include a micro lens 302 and an image sensor 304, which can correspond to micro lens 102 in FIG. 1 and/or micro lens 202 in FIG. 2 and image sensor 104 in FIG. 1 and/or image sensor 204 in FIG. 2, respectively. The micro lens 302 can include embedded optics 306. The embedded optics 306 can correspond to embedded optics 206 in FIG. 2. As illustrated in FIG. 3, the apparatus 300 can further include a memory 312, a processing resource 314, and a communication link 316.

The memory 312 can be coupled to the processing resource 314 and the memory 312 can be any type of storage medium that can be accessed by the processing resource 314 to perform various examples of the present disclosure. For example, the memory 312 can be a non-transitory computer readable medium having computer readable instructions (e.g., computer program instructions) stored thereon that are executable by the processing resource 314 to receive light at the image sensor 304 and generate an image from the received light at the image sensor 304.

The processing resource 314 can combine one or more of the generated images to create a picture and/or video. The processing resource 314 can receive the one or more generated images from one or more image sensors 304 and/or from memory 312. In some examples, the processing resource 314 can combine an image from the image sensor 304 with an image from the memory 312.

In a number of embodiments, the memory 312 can be coupled to the image sensor 304 and can store one or more images from the image sensor 304. In some examples, the picture created by the processing resource 314 can be stored in memory 312.

The memory 312 can be volatile or nonvolatile memory. The memory 312 can also be removable (e.g., portable) memory, or non-removable (e.g., internal) memory. For example, the memory 312 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 312 is illustrated as being located within apparatus 300, embodiments of the present disclosure are not so limited. For example, memory 312 can be located on an external apparatus (e.g., enabling computer readable instructions to be downloaded over the Internet or another wired or wireless connection).

The apparatus 300 can send the one or more images, the picture, and/or a video to a computing device. The computing device can be, for example, a personal laptop, a desktop computer, a smart phone, a wrist worn device, a server, or a cloud computing system. The data can be sent via communication link 316.

The communication link 316 can be a network relationship through which the apparatus 300 communicates with one or more computing devices. Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. For instance, the network can include a number of servers that receive information from and transmit information to apparatus 300 and/or computing devices via a wired or wireless network.

FIG. 4 is a flow diagram of a method 420 for receiving light, via an array of micro lenses including embedded optics, at an array of image sensors in accordance with a number of embodiments of the present disclosure. At block 422, the method 420 can include receiving light, via an array of micro lenses including embedded optics configured to reduce diffraction relative to a threshold value associated with another array of micro lenses without embedded optics, at an array of image sensors coupled to the array of micro lenses and positioned to receive the light in response to the light passing through the array of micro lenses.

In some examples, the light can be a Gaussian beam. The embedded optics can convert the Gaussian beam to a Bessel-Gaus beam to provide the image sensor with light with less diffraction or no diffraction. The embedded optics can include an axicon, a cubic phase plate, and/or a polarization conversion plate to convert the Gaussian beam to a Bessel-Gaus beam.

The image sensor can be, for example, a complementary metal oxide semiconductor (CMOS) sensor and/or a charge-coupled device (CCD). A CMOS sensor can include a number of metal-oxide-semiconductor field-effect transistor (MOSFET) amplifiers and a CCD can include a number of metal-oxide-semiconductor (MOS) capacitors. In some examples, image sensors can be included in digital cameras, camera modules, camera phones, medical imaging equipment, night vision, radar, and sonar.

At block 424, the method 420 can include generating an image from the light at the array of image sensors based at least in part on reduced diffraction of the light. The image sensor can convert a number of photons from the light to a number of electrons to generate an image. In some examples, an apparatus including an axicon, a cubic phase plate, and/or a polarization conversion plate and an image sensor can capture an image at a greater distance away from the apparatus than an apparatus including the image sensor without the axicon, the cubic phase plate, and/or the polarization conversion plate.

A processing resource can combine one or more of the generated images to create a picture and/or video. The processing resource can receive the one or more generated images from one or more image sensors and/or from memory. In some examples, the processing resource can combine an image from the image sensor with an image from the memory.

In a number of embodiments, the memory can store one or more images from the one or more image sensors. In some examples, the picture created by the processing resource can be stored in memory.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving light, via an array of micro lenses including embedded optics configured to reduce diffraction relative to a threshold value associated with another array of micro lenses without embedded optics, at an array of image sensors coupled to the array of micro lenses and positioned to receive the light in response to the light passing through the array of micro lenses; and
generating an image from the light at the array of image sensors based at least in part on reduced diffraction of the light.

2. The method of claim 1, further comprising sending the image to a computing device.

3. The method of claim 1, further comprising converting a number of photons from the received light to a number of electrons to generate the image from the light at the array of image sensors.

4. The method of claim 1, further comprising at least one of increasing a depth of focus of the image or increasing a signal to noise ratio of the light in response to the light passing through the array of micro lenses.

5. The method of claim 1, further comprising receiving the light as a Gaussian beam at the array of micro lenses.

6. The method of claim 1, further comprising creating a Bessel-Gauss beam from the light in response to passing the light through the array of micro lenses.

7. The method of claim 1, further comprising passing a portion of the light through each micro lens of the array of micro lenses.

8. The method of claim 1, further comprising receiving a portion of the light at each image sensor of the array of image sensors.

9. An apparatus, comprising:
an array of micro lenses including embedded optics configured to reduce diffraction relative to a threshold value associated with another array of micro lenses without embedded optics; and
an array of image sensors coupled to the array of micro lenses configured to:
receive the light in response to the light passing through the array of micro lenses; and
generate an image from the light based at least in part on reduced diffraction of the light.

10. The apparatus of claim 9, wherein each image sensor of the array of image sensors is a complementary metal oxide semiconductor (CMOS) sensor or a charge-coupled device (CCD)

11. The apparatus of claim 9, wherein the array of micro lenses are embedded in the circuitry of the apparatus.

12. The apparatus of claim 9, wherein each image sensor of the array of image sensors includes a number of metal-oxide-semiconductor field-effect transistor (MOSFET) amplifiers or a number of metal-oxide-semiconductor (MOS) capacitors.

13. The apparatus of claim 9, wherein the embedded optics includes at least one of an axicon, a cubic phase plate, a radial polarization conversion plate, an azimuthal polarization conversion plate, or a linear polarization conversion plate.

14. The apparatus of claim 9, further comprising a memory coupled to the array of image sensors.

15. The apparatus of claim 9, further comprising a communication link configured to send the image to a computing device.

16. An apparatus, comprising:
an array of micro lenses each including embedded optics configured to reduce diffraction relative to a threshold value associated with another array of micro lenses without embedded optics;
an array of image sensors coupled to the array of micro lenses, wherein each image sensor of the array of image sensors is configured to:
receive a portion of the light in response to the light passing through the array of micro lenses; and
generate an image from the portion of the light based at least in part on reduced diffraction of the portion of the light; and
a processing resource configured to combine the images from the array of image sensors to create a picture.

17. The apparatus of claim 16, wherein the apparatus is a security camera or a baby monitor.

18. The apparatus of claim 16, further comprising a memory coupled to the processing resource.

19. The apparatus of claim 18, wherein the memory is configured to store the images from the array of image sensors.

20. The apparatus of claim 18, wherein the memory is configured to store the picture.
